(19) United States
(12) Patent Application Publication
(10) Pub. No.: US 2018/0276320 A1
(43) Pub. Date: Sep. 27, 2018

(54) SYSTEMS AND METHODS FOR GENERATING MULTI-FUNCTIONAL ARCHITECTURAL DESIGN FOR FACILITATING INTER-ENVIRONMENTAL ARCHITECTURE IMPLEMENTATION

(71) Applicant: Tata Consultancy Services Limited, Mumbai (IN)

(72) Inventors: Anand KUMAR, Pune (IN); Kesav Vithal NORI, Hyderabad (IN)

(73) Assignee: Tata Consultancy Services Limited, Mumbai (IN)

(21) Appl. No.: 15/926,018

(22) Filed: Mar. 20, 2018

(30) Foreign Application Priority Data
Mar. 21, 2017 (IN) 201721009910

(51) Int. Cl. G06F 17/50

(52) U.S. Cl. CPC G06F 17/5004; G06F 2217/02

(57) ABSTRACT

Systems and methods for generating multi-functional architectural design to facilitate an inter-environmental architecture implementation in a computing device. The traditional systems and methods consider a single architecture technique as a collection of activities and do not semantically support the process of architecting. Embodiment of the present disclosure provide for generating the multi-functional architectural design to facilitate the inter-environmental architecture implementation by defining a plurality of architectural components, gathering a set of unstructured architectural problems, transforming the set of unstructured architectural problems into a set of structured architectural information, performing an analysis of a set of architectural solutions, formulating, by an architecture technique 204, a set of potential architectural designs, identifying a final architectural design and generating a final set of integrated architectural descriptions, wherein the final set of integrated architectural descriptions correspond to the one or more potential architectural solutions amongst the set of potential architectural solutions.

### PRIORITY CLAIM

This U.S. patent application claims priority under 35 U.S.C. § 119 to: India Application No. 201721009910, filed on Mar. 21, 2017. The entire contents of the aforementioned application are incorporated herein by reference.

### TECHNICAL FIELD

This disclosure relates generally to facilitating architectural design, and more particularly to systems and methods for generating multi-functional architectural design to facilitate an inter-environmental architecture implementation in a computing device.

### BACKGROUND

Over the recent past, software systems have become larger, complex and sophisticated. Consequently, asserting overall software quality of any such software system may present difficult challenges. Software architecture addresses these challenges up to a certain extent and proved to be a key to address software quality of such software systems. Software architecture herein refers to the high level structures of software systems. Software architecture is a synthesis of components, which enables behavioral processes pertaining to such software system, however software architecture does not specify any behavioral processes. Software architecting is the process of defining, synthesizing and composing components, a corresponding run-time component, and predominantly involves identifying such components that should be coupled and identifying other components that should exist independently in such a way that the external problem domain needs of the software are met.

The traditional systems and methods illustrate numerous architectural frameworks, wherein such architectural frameworks serve as reference architectures for software architects. The traditional systems and methods also illustrate a variety of architectural styles in practice, however they are essentially partial architectures. The existing architectural styles or frameworks cater to different concerns dominated by interoperability, information exchange, interchange issues, also changing requirements and differing policies and inherently support a set of capabilities and an elemental structure. Such architectural styles or frameworks establish a common practice for creating, interpreting, analyzing and using architecture design elements within a particular domain of application or stakeholder community. The existing architectural styles or frameworks does not address the question if there is a meta-architecture or underlying architecture whose instances are these architecture frameworks and architecture styles.

Solution illustrated by the traditional systems and methods have very little software support for the process of architecting. Software architecting is manual intellectual work. While there are various tools available to capture architecture description and templates to aid in preparing the architecture description, there are no tools that support architecting. The traditional systems and methods fundamentally lack a formal method to describe architecture processes. Also, the various artefacts arising out of the existing state-of-the-art practices are unstructured. Further, the traditional systems and methods also consider a single architecture technique as a collection of activities and look at developing software that support these activities, however they do not semantically support the process of architecting. Finally, the traditional systems and methods practices do not capture the resultant architectural abstractions, which requires getting beyond the virtual or apparent details that are visible and it is lacking in any of the prior art solution. Thereby, a multi-functional architecture design facilitation environment is still considered as one of the biggest challenges of the technical domain.

### SUMMARY

Embodiments of the present disclosure present technological improvements as solutions to one or more of the above-mentioned technical problems recognized by the inventors in conventional systems. For example, in one embodiment, a method for generating multi-functional architectural design to facilitate an inter-environmental architecture implementation in a computing device is provided, the method comprising: defining, by one or more hardware processors, a plurality of architectural components, wherein the plurality of architectural components comprise a plurality of architecting workspaces, an architecture technique, a run-time and an architecture repository, and wherein the plurality of architecting workspaces comprise inter-alia of a process model and a component model; obtaining, from the architecture repository, an unstructured set of information comprising of an analytical data and a non-analytical data relevant to a set of architectural problems, wherein the unstructured set of information is gathered from a plurality of sources; transforming, by performing a plurality of steps, the unstructured set of information into a structured set of information by the plurality of architecting workspaces, wherein the plurality of steps comprise: (a) generating, by implementing one or more analysis techniques, a first set of information comprising of analysis on the set of architectural problems; (b) defining a plurality of information entities corresponding to the set of architectural problems; synthesizing, using the plurality of information entities, a second set of information, wherein the second set of information comprises a plurality of data, models and solutions corresponding to the set of architectural problems; (d) generating, by implementing the one or more analysis techniques, a third set of information comprising of analysis on a set of architectural solutions; (e) identifying, based upon the third set of information, a set of potential architectural solutions; and (f) formulating, by the architecture technique, a set of potential architectural designs, wherein the set of potential architectural designs correspond to one or more architectural solutions amongst the set of potential architectural solutions identified; performing, based upon the structured set of information, at least one of one of below by implementing the architecture technique: (a) logically integrating in a hierarchy a plurality of architecture artefacts and a plurality of architecture work-products; (b) mapping the first set of information, the second set of information, the third set of information, the set of potential architectural designs and the set of potential architectural solutions; and (c) generating, using one or more architectural description techniques, a fourth set of information comprising one or more architectural descriptions, views and models corresponding to each potential architecture solution amongst the set of potential architectural solutions; and facilitating, based upon the one or more architectural description techniques and the mapping, the inter-environmental architecture implementation by: (a) identifying a final architectural design amongst the set of potential architectural designs, wherein the final architectural design corresponds to one or more potential architectural solutions amongst the set of potential architectural solutions; and (b) generating a final set of integrated architectural descriptions, wherein the final set of integrated architectural descriptions correspond to the one or more potential architectural solutions amongst the set of potential architectural solutions; formulating the set of potential architectural designs by evaluating, based upon one or more evaluation techniques, the set of potential architectural designs for generating the multi-functional architectural design, and wherein the evaluation comprises analyzing the set of potential architectural designs using the one or more analysis techniques; formulating the set of potential architectural designs by identifying, based upon at least one of a built-in function or a plug-in function, a set of functionalities and a set of architectural resources to execute the plurality of architectural components; defining a potential architecture design amongst the set of potential architectural designs by at least one of one or more Architecture Description Languages (ADL) or one or more Architecture Description Models (ADM); defining a plurality of tasks for executing the architecture technique based upon the process model; defining one or more sequences corresponding to the plurality of tasks based upon the process model, and wherein the one or more sequences determine the order in which the plurality of tasks are to be executed; and identifying the final architectural design by defining a unified standard of interaction corresponding to the defined plurality of architectural components based upon the component model.

In another aspect, there is provided a system for generating multi-functional architectural design to facilitate an inter-environmental architecture implementation in a computing device, the system comprising a memory storing instructions; one or more communication interfaces; and one or more hardware processors coupled to the memory via the one or more communication interfaces, wherein the one or more hardware processors are configured by the instructions to: define, by the one or more hardware processors, a plurality of architectural components, wherein the plurality of architectural components comprise a plurality of architecting workspaces, an architecture technique, a run-time and an architecture repository, and wherein the plurality of architecting workspaces comprise inter-alia of a process model and a component model; obtain, from the architecture repository, an unstructured set of information comprising of an analytical data and a non-analytical data relevant to a set of architectural problems, wherein the unstructured set of information gathered from a plurality of sources; transform, by performing a plurality of steps, the unstructured set of information into a structured set of information by the plurality of architecting workspaces, wherein the plurality of steps comprise: (a) generate, by implementing one or more analysis techniques, a first set of information comprising of analysis on the set of architectural problems; (b) define a plurality of information entities corresponding to the set of architectural problems; (c) synthesize, using the plurality of information entities, a second set of information, wherein the second set of information comprises a plurality of data, models and solutions corresponding to the set of architectural problems; (d) generate, by implementing the one or more analysis techniques, a third set of information comprising of analysis on a set of architectural solutions; (e) identify, based upon the third set of information, a set of potential architectural solutions; and (f) formulate, by the architecture technique, a set of potential architectural designs, wherein the set of potential architectural designs correspond to one or more architectural solutions amongst the set of potential architectural solutions identified; perform, based upon the structured set of information, at least one of one of below by implementing the architecture technique: (a) logically integrate in a hierarchy a plurality of architecture artefacts and a plurality of architecture work-products; (b) map the first set of information, the second set of information, the third set of information, the set of potential architectural designs and the set of potential architectural solutions; and (c) generate, using one or more architectural description techniques, a fourth set of information comprising one or more architectural descriptions, views and models corresponding to each potential architecture solution amongst the set of potential architectural solutions; facilitate, based upon the one or more architectural description techniques and the mapping, the inter-environmental architecture implementation by: (a) identify a final architectural design amongst the set of potential architectural designs, wherein the final architectural design corresponds to one or more potential architectural solutions amongst the set of potential architectural solutions; and (b) generate a final set of integrated architectural descriptions, wherein the final set of integrated architectural descriptions correspond to the one or more potential architectural solutions amongst the set of potential architectural solutions; formulate the set of potential architectural designs by evaluating, based upon one or more evaluation techniques, the set of potential architectural designs for generating the multi-functional architectural design, and wherein the evaluation comprises analyzing the set of potential architectural designs using the one or more analysis techniques; formulate the set of potential architectural designs by identifying, based upon at least one of a built-in function or a plug-in function, a set of functionalities and a set of architectural resources to execute the plurality of architectural components; define a potential architecture design amongst the set of potential architectural designs by at least one of one or more Architecture Description Languages (ADL) or one or more Architecture Description Models (ADM); define a plurality of tasks for executing the architecture technique based upon the process model; define one or more sequences corresponding to the plurality of tasks based upon the process model, wherein the one or more sequences determine the order in which the plurality of tasks are to be executed; and identify the final architectural design by defining a unified standard of interaction corresponding to the defined plurality of architectural components based upon the component model.

In yet another aspect, there is provided one or more non-transitory machine readable information storage mediums comprising one or more instructions which when executed by one or more hardware processors causes the one or more hardware processor to perform a method for generating multi-functional architectural design to facilitate an inter-environmental architecture implementation in a computing device, the method comprising: defining, by the one or more hardware processors, a plurality of architectural components, wherein the plurality of architectural components comprise a plurality of architecting workspaces, an architecture technique, a run-time and an architecture repository, and wherein the plurality of architecting workspaces comprise inter-alia of a process model and a component model; obtaining, from the architecture repository, an unstructured set of information comprising of an analytical data and a non-analytical data relevant to a set of architectural problems, wherein the unstructured set of information is gathered from a plurality of sources; transforming, by performing a plurality of steps, the unstructured set of information into a structured set of information by the plurality of architecting workspaces, wherein the plurality of steps comprise: (a) generating, by implementing one or more analysis techniques, a first set of information comprising of analysis on the set of architectural problems; (b) defining a plurality of information entities corresponding to the set of architectural problems; synthesizing, using the plurality of information entities, a second set of information, wherein the second set of information comprises a plurality of data, models and solutions corresponding to the set of architectural problems; (d) generating, by implementing the one or more analysis techniques, a third set of information comprising of analysis on a set of architectural solutions; (e) identifying, based upon the third set of information, a set of potential architectural solutions; and (f) formulating, by the architecture technique, a set of potential architectural designs, wherein the set of potential architectural designs correspond to one or more architectural solutions amongst the set of potential architectural solutions identified; performing, based upon the structured set of information, at least one of one of below by implementing the architecture technique: (a) logically integrating in a hierarchy a plurality of architecture artefacts and a plurality of architecture work-products; (b) mapping the first set of information, the second set of information, the third set of information, the set of potential architectural designs and the set of potential architectural solutions; and (c) generating, using one or more architectural description techniques, a fourth set of information comprising one or more architectural descriptions, views and models corresponding to each potential architecture solution amongst the set of potential architectural solutions; and facilitating, based upon the one or more architectural description techniques and the mapping, the inter-environmental architecture implementation by: (a) identifying a final architectural design amongst the set of potential architectural designs, wherein the final architectural design corresponds to one or more potential architectural solutions amongst the set of potential architectural solutions; and (b) generating a final set of integrated architectural descriptions, wherein the final set of integrated architectural descriptions correspond to the one or more potential architectural solutions amongst the set of potential architectural solutions; formulating the set of potential architectural designs by evaluating, based upon one or more evaluation techniques, the set of potential architectural designs for generating the multi-functional architectural design, and wherein the evaluation comprises analyzing the set of potential architectural designs using the one or more analysis techniques; formulating the set of potential architectural designs by identifying, based upon at least one of a built-in function or a plug-in function, a set of functionalities and a set of architectural resources to execute the plurality of architectural components; defining a potential architecture design amongst the set of potential architectural designs by at least one of one or more Architecture Description Languages (ADL) or one or more Architecture Description Models (ADM); defining a plurality of tasks for executing the architecture technique based upon the process model; defining one or more sequences corresponding to the plurality of tasks based upon the process model, and wherein the one or more sequences determine the order in which the plurality of tasks are to be executed; and identifying the final architectural design by defining a unified standard of interaction corresponding to the defined plurality of architectural components based upon the component model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system for generating multi-functional architectural design to facilitate an inter-environmental architecture implementation in a computing device in accordance with some embodiments of the present disclosure.

FIG. 2A through 2B is an architecture depicting the components of the system for generating the multi-functional architectural design to facilitate the inter-environmental architecture implementation in the computing device in accordance with some embodiments of the present disclosure.

FIG. 3A through 3D is a flow diagram illustrating the steps involved in the process of generating the multi-functional architectural design to facilitate the inter-environmental architecture implementation in the computing device in accordance with some embodiments of the present disclosure.

FIG. 4 illustrates a plurality of information entities corresponding to a set of architectural problems in accordance with some embodiments of the present disclosure.

FIG. 5 illustrates an example of a potential architectural design formulated in the process of generating the multi-functional architectural design to facilitate the inter-environmental architecture implementation in the computing device in accordance with some embodiments of the present disclosure.

FIG. 6 shows an example of a logical integration of a plurality of architecture artefacts and a plurality of architecture work-products in a hierarchy in accordance with some embodiments of the present disclosure.

FIG. 7 shows an example of one or more architectural descriptions, views and models corresponding to each of potential architecture solution amongst a set of potential architectural solutions in accordance with some embodiments of the present disclosure.

FIG. 8 shows another example of the one or more architectural descriptions, views and models corresponding to each of the potential architecture solution amongst the set of potential architectural solutions in accordance with some embodiments of the present disclosure.

FIG. 9A through 9B illustrates an example of mapping performed by implementing an architecture technique component and also shows an example of a final architectural design identified in the process of generating the multi-functional architectural design to facilitate the inter-environmental architecture implementation in the computing device in accordance with some embodiments of the present disclosure.

FIGS. 10 and 11 show an example of facilitating the inter-environmental architectural implementation via the proposed methodology to generate the one or more architectural descriptions, views and models in another architecture problem domain in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Systems and methods for generating multi-functional architectural design to facilitate an inter-environmental architecture implementation in a computing device are described herein. An architecture (or a software architecture) is a static structural composition of components, wherein, components are analogous to “containers of information and their associated operations”. A Component encapsulates information, a set of access methods and operations and may comprise other components. The represented information can change but the access methods and the operations remain the same over the time period of existence of the component. There could be two kinds of Components. One type of Component is a contained space and associated flows to access the contained space. The other type of component is transformational in nature. It supports either the transformation of the state of the contained space or transformation of one contained space into another.

The act of architectural design creates complex configurations from the basic architectural design elements like spaces and flow. It is through these patterns that a system acquires the potential to satisfy the desired properties. There exist commonalities in the way the different spaces and flows are organized. Such common configurational patterns characterize the software as a whole and also syntactically carry a signature of style and are the Archetypes for Architectural Design.

The act of Architecture unravels a possible space of solutions. Architectural design translates such architectural possibilities to architectural specificity. The objective of Architectural design then is to create a representation of an unknown and original object whose properties must be well enough understood in advance. The property that must be predicted includes technical aspects, formal structure and spatial structure. The problem of architectural design involves generation of the proposed form and prediction of its functional properties before its embodiment using given resources. It involves understanding how the resources necessary for creating this form is organized formally, semantically and how it is represented and how these representations can be acted to produce effective transformations.

Hence, there is need for a technology that provides for facilitating system architectural design, facilitating architecting processes in general and architectural design in particular by way of providing an environment that facilitates system architectural design, that support system architects in formulating and resolving their architecture design problem towards realizing their architectural responsibilities, define the architecting problems which involve identifying the purpose of architecture, facilitates identifying a desired value adding qualities from an understanding of user needs, facilitates identification of architectural elements that comprise the design and identification of architectural archetypes to be used and planning and preparing the design methodology to be adopted, resolving the architectural design problems which involve identifying components, creating spatial structures that represent these components, represent these structures as architecture model(s) within the defined constraints.

Further, the technology must facilitate ease of interoperation and data transfer; an approach to model and execute architecture processes; a unified model of the collected information facilitating interoperability; facilitates analysis of an architecture based on many analysis techniques; facilitate description of an architecture using multiple architecture description languages; and facilitate generation of architecture views based on pre-defined viewpoints.

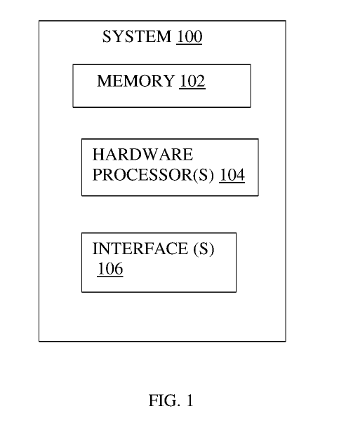

Referring now to the drawings, and more particularly to FIGS. 1 through 11, where similar reference characters denote corresponding features consistently throughout the figures, there are shown preferred embodiments and these embodiments are described in the context of the following exemplary system and/or method.

FIG. 1 illustrates an exemplary block diagram of a system 100 for generating the multi-functional architectural design to facilitate the inter-environmental architecture implementation in the computing device according to an embodiment of the present disclosure. In an embodiment, the system 100 includes one or more processors 104, communication interface device(s) or input/output (I/O) interface(s) 106, and one or more data storage devices or memory 102 operatively coupled to the one or more processors 104. The one or more processors 104 that are hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

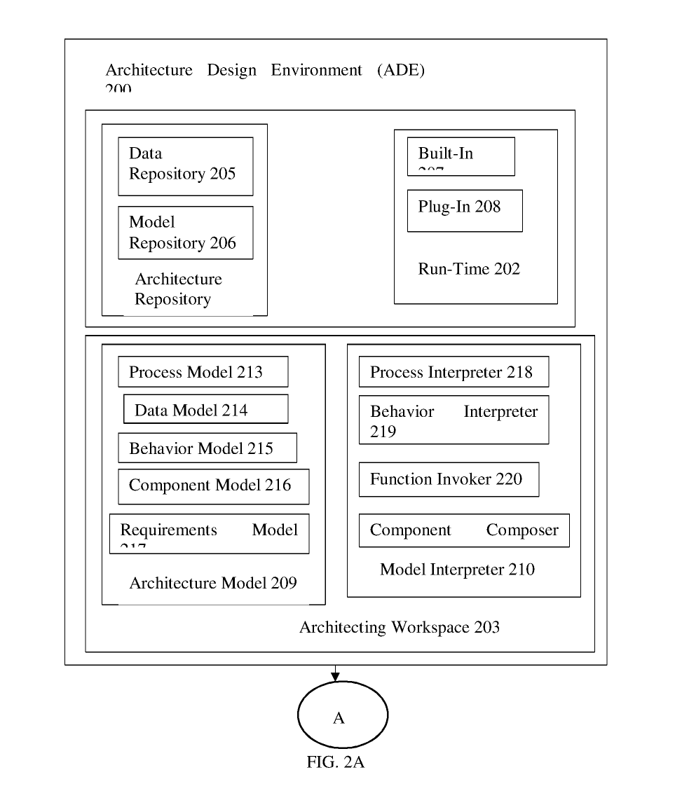

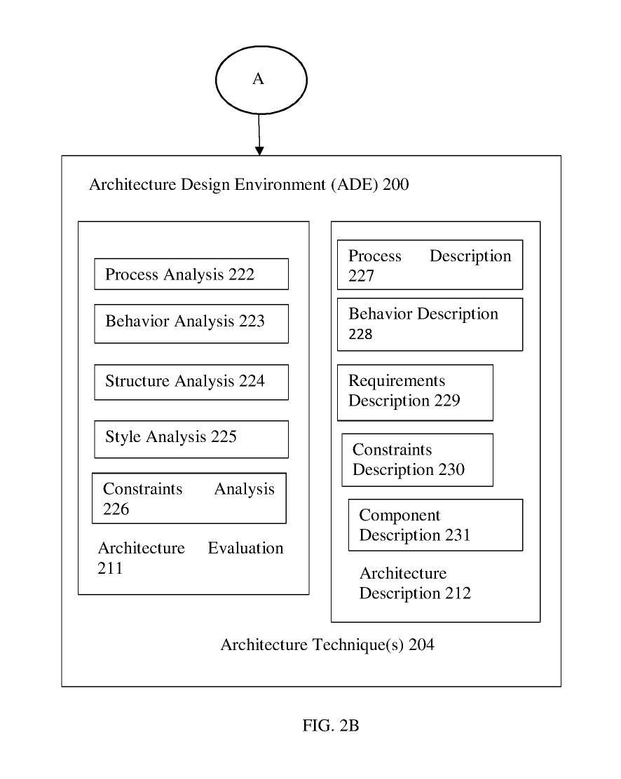

According to an embodiment of the present disclosure, referring to FIG. 2A through 2B, the architecture and components (hereinafter referred to as a plurality of architectural components) of the system 100 for generating the multi-functional architectural design to facilitate the inter-environmental architecture implementation in the computing device may be referred. In an embodiment, referring to FIG. 2A through 2B, it may be noted that the plurality of architectural components are defined and integrated via an Architecture Design Environment (ADE) 200. The architecture and functions of the plurality of architectural components may thus be defined via reference with the ADE 200.

According to an embodiment of the present disclosure, the ADE 200 comprises an architecture repository 201, a run-time 202, a plurality of architecting workspaces 203, and an architecture technique 204.

In an embodiment, the ADE 200 comprises of the plurality of architecting workspaces 203. The plurality of architecting workspaces 203 are placeholders for performing architecting tasks and displays the current status of the different architecture problems. The plurality of architecting workspace 203 facilitates handling of multiple architecture problems and provides access to wizards that aid in adopting the architecture technique 204. The plurality of architecting workspaces 203 also supports evaluation and description of architectures.

In an embodiment, the ADE 200 comprises the architecture technique 204. The architecture technique 204 is a placeholder for identifying potential architectures for an architecture problem. The architecture technique 204 brings together key decisions necessary for arriving at an architecture including value, quality, function, context, process and structure thereby facilitating the composition of the building blocks of the Software. The architecture technique 204 facilitates multiple descriptions of architecture as well as multiple ways of evaluating architectures.

In an embodiment, the plurality of architecting workspaces 203 comprise a composition of an architecture model 209 and a model interpreter component 210. The architecture model 209 further comprises of a process model 213, a data model 214, a behavior model 215, a component model 216 and a requirements model component 217. The model interpreter 210 further comprises of a process interpreter 218, a behavior interpreter 219, a function invoker 220 and a component composer component 221.

In another embodiment of the present disclosure, the architecture model 209 serves as the specification of a computer system (wherein the computer system is a system other than the system 100), using which architects can structure, identify, analyze and synthesize design. The architecture model 209 is approximations constrained by the architects' knowledge and ability to use it to induce acceptable quality. The architecture model 209 usually is symbolic and contains information expressed in specific forms and require interpretation according to predefined rules. The architecture model 209 is necessary to capture different characteristics. The various entities in the architecture model 209 are manipulated to create a formal or logical structure. These structures serve as the basis for understanding and interpretation of the architectural abstractions.

In an embodiment, an architecture evaluation 211 is the placeholder for determining if the architecture is designed so that it fulfills its intended purpose; delivers desired qualities and satisfies identified stakeholder requirements. The architecture evaluation 211 takes into account impact of whole architecture. Multiple techniques are necessary to capture different characteristics. They serve as the basis for understanding and analysis of architecture.

In an embodiment, the process model 213 is the placeholder for the architecting processes that are composed together into a model. The process model 213 declares the tasks, which an architect performs for the architecture technique 204, and their sequence, wherein outcome of these tasks contribute to the solution of the architecture problem.

In an embodiment, the data model 214 is the placeholder for the ADE 200 data that are composed together into a concrete model so as to define information needs for solving the architecting problem. The data model 214 facilitates definition of the architecture problem in terms of problem entities and corresponding relationships. The data model 214 documents and organizes these elements and standardizes how they relate to each other.

In an embodiment of the present disclosure, the behavior model 215 is the placeholder in the ADE 200 that relates to how the desired behavior of the architecture should be specified. The behavior model 215 serves as the basis for communication between various stakeholders. The behavior model 215 facilitates definition of the architecture problem in terms of scenarios and specifications (states and transitions). The behavior model 215 documents and organizes these elements and standardizes how they relate to each other.

In an embodiment, the component model 216 is the place holder for the components and their interactions of the designed architectural solution. The component model 216 facilitates definition of the solution in terms of components and their compositions. The component model 216 facilitates specification of richer types of component interactions by defining an interaction standard. The component model 216 defines permitted mechanisms for creating and assembling components.

In an embodiment, the requirements model component 217 is the placeholder for various stakeholder needs and domain characteristics that are composed together into a concrete model so as to define the system requirements. Such a model aids in elicitation, uncovering problem entities, check the architects understanding of the problem area. The requirements model component 217 documents and organizes these elements and standardizes how they relate to each other.

In an embodiment, the architecture technique 204 is a composition of the architecture evaluation 211 and an architecture description component 212. The architecture evaluation 211 further comprises of a process analysis 222, a behavior analysis 223, a structure analysis 224, a style analysis 225 and a constraints analysis component 226. The architecture description 212 further comprises of a process description 227, a behavior description 228, a requirements description 229, a constraints description 230 and a component description component 231.

In an embodiment of the present disclosure, the architecture repository 201 is a composition of a data repository 205 and a model repository 206. The architecture repository 201 is a placeholder for data relevant to architecture problems corresponding to the architecture technique 204 and models that are used to solve these problems. The architecture repository 201 ensures that the data and models are always available to the user and provides functionality to manipulate and selectively access them.

In an embodiment of the present disclosure, the run-time 202 is a composition of a built-in function (or built-in) 207 and a plug-in function (or plug-in) 208. The run-time 202 provides functionality and resources needed by the ADE 200, for example, Application Programming Interfaces (APIs), Remote APIs, Processing power, storage facilities etc. The run-time 202 provides the necessary infrastructure for realization of the architecture technique 204, basic services necessary for the various components to work together; and supports extensibility of some chosen kinds of components. The run-time 202 comprises of some functions which are the built-in function 207 into the run-time 202 and the plug-in function 208 which are plugged in during execution.

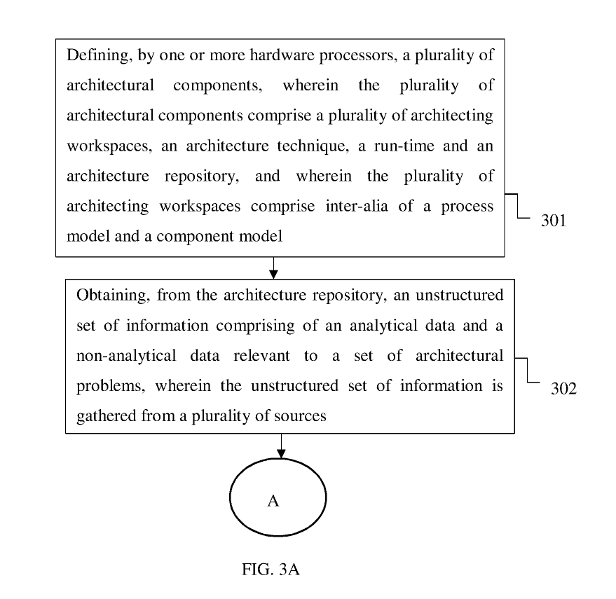

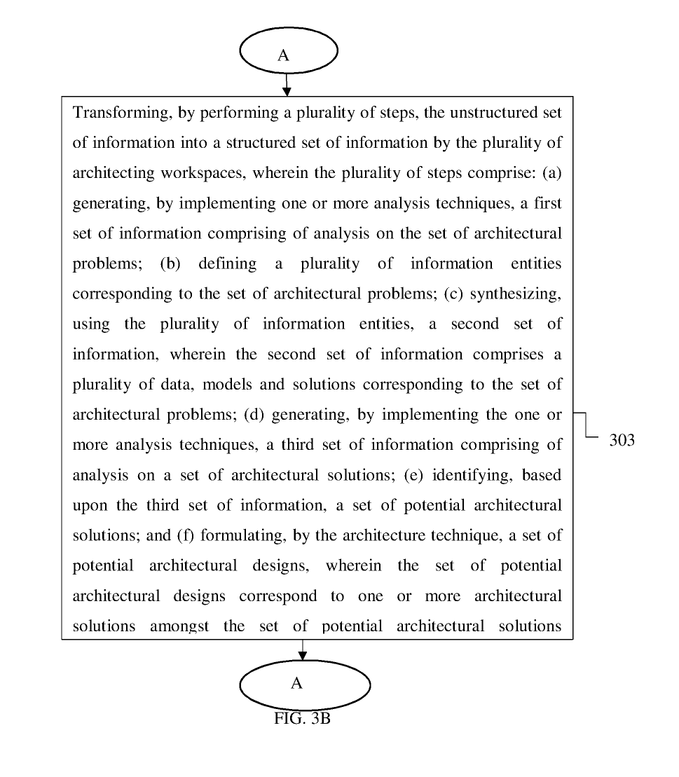

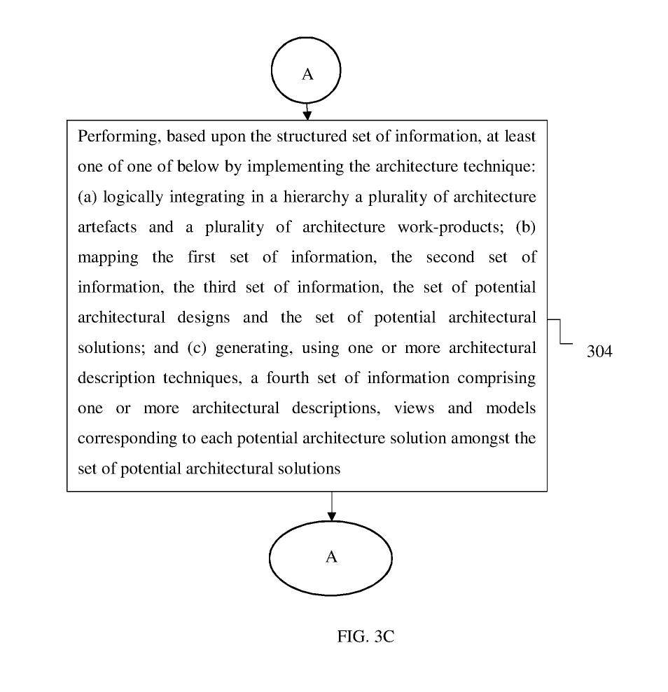

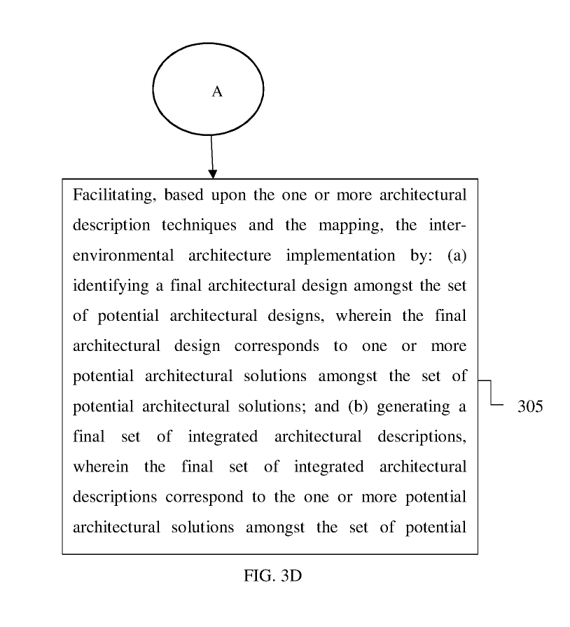

FIG. 3A through 3D, with reference to FIGS. 1 through 2B, illustrates an exemplary flow diagram of a method for generating the multi-functional architectural design to facilitate the inter-environmental architecture implementation in the computing device, in accordance with some embodiments of the present disclosure. In an embodiment the system 100 comprises one or more data storage devices of the memory 102 operatively coupled to the one or more hardware processors 104 and is configured to store instructions for execution of steps of the method by the one or more processors 104. The steps of the method of the present disclosure will now be explained with reference to the components of the system 100 as depicted in FIG. 1 and the flow diagram. In the embodiments of the present disclosure, a policy based access control shall be implemented in the system 100. In the embodiments of the present disclosure, the hardware processors 104 when configured the instructions performs one or more methodologies described herein.
Note—The term ‘computing device’ as used in the proposed disclosure may comprise a computer system, laptop, keyboard etc. or any other computing device further comprising of all hardware and software components such as a memory, hardware processor/s, mouse, operating system, memory, peripheral devices etc. which are required to make the computing device capable of executing all tasks via a set of instructions, for example, programs. Further, the computing device on which the methodology for generating the multi-functional architectural design to facilitate the inter-environmental architecture implementation has been implemented and tested, may be similar to or different from the system 100 referred to in this disclosure. The computing device has not been shown separately. Still further, the term ‘architecture’, the related components thereof and also the multi-functional architectural design and other related terminologies used in the proposed disclosure correspond to software architecture(s) in any computing device.

The process of generating the multi-functional architectural design to facilitate the inter-environmental architecture implementation by the ADE 200 and the plurality of architectural components defined may now be considered in detail.

In general, components refers to the fundamental building blocks of computer system(s) (that is a system other than the system 100) and it is by putting together a logical static structure of the components that a system architecture is realized. In an embodiment, the components may be considered as a general abstraction based on which a software system elements of a system architecture is defined. A Component may be considered as a notional environment that lies within the confines of computer system (that is a system other than the system 100), and represents the most fundamental element of computer system that enables it to perform its function.

In an embodiment, the plurality of architectural components may be considered as containers of information and their operations. It is a symbolic name for (or reference to) information that a computer system (that is a system other than the system 100) manipulates. While one or more components (amongst the plurality of architectural components) may encapsulate information, a set of access methods and transformative operations, a composite component may encapsulate information, a set of access methods, transformative operations and other components that are part of a composition. The represented information can change but the access methods and the operations remain the same over the time period of existence of the plurality of architectural components. In an embodiment, the plurality of architectural components exhibit state and behavior wherein state corresponds to the state of the information resources and behavior corresponds to the operations that are permissible on these information resources.

According to an embodiment of the present disclosure, at step 301, the one or more hardware processors 104 define the plurality of architectural components, wherein the plurality of architectural components comprise the architecture repository 201, the run-time 202, the architecting workspace 203 and the architecture technique 204, (discussed in the preceding paragraphs via the architecture diagram), and wherein the architecting workspace 203 comprises inter-alia, of the process model 213 and the behavior model 215 (discussed in the preceding paragraphs via the architecture diagram).

In an embodiment, the step of defining the plurality of architectural components comprises defining a plurality of tasks for executing the architecture technique 204 based upon the process model 213. In an example scenario, in case of robotic process deployment for an event based company, the plurality of tasks may comprise modelling the process, obtaining transactional data etc. Further, defining the plurality of tasks comprises defining one or more sequences corresponding to the plurality of tasks based upon the process model 213, wherein the one or more sequences determine the order in which the plurality of tasks are to be executed. In an example scenario, the one or more sequences corresponding to the plurality of tasks may comprise identifying standardized data, defining technical processes, defining process programs, modeling environment, process management, process enactment and finally automating transactions.

According to an embodiment of the present disclosure, at step 302, the one or more hardware processors 104 obtain, from the architecture repository 201, an unstructured set of information comprising of analytical and non-analytical data relevant to a set of architectural problems, wherein the unstructured set of information may be identified and gathered from a plurality of sources. The plurality of sources may comprise of existing set(s) of architectural problems and architectural workbenches. The identification of the unstructured set of information may be performed via the architectural workbenches, and the architectural workbenches facilitate, inter-alia, visualizing relationships between data and designing and editing of relationship tables. In an embodiment, the unstructured information identified and gathered from the plurality of sources may be stored in the architecture repository 201.

In an example implementation for the step 302, the set of architectural problems may be identified and gathered for a corporate entity company looking to adopt digital or robotic technologies for event management as below:
“Primarily the corporate entity not an event management company and is essentially consumer of event management services and therefore they do not know the nuances of event management”
“Corporate events have limited scale and scope and are predominantly corporate events, targeted for specific segments (employees, customers, top management etc., and participants are invited (no tickets and all expenses are borne by the corporate)
“Corporate use limited technology support for event management comprising of few applications and few general tools”

Corporate event management is ad-hoc, sporadic and dependent on the hosting team for the event's success”.

According to an embodiment of the present disclosure, at step 303, the one or more hardware processors 104 transform, by performing a plurality of steps, the unstructured set of information into a structured set of information via the plurality of architecting workspaces 203. At step 303(a) a first set of information comprising of analysis on the set of architectural problems may be generated. The first set of information further formulates analytical and other relevant information corresponding to the set of architectural problems. In an example implementation, the first set of information may be generated as:
“Multiple users login daily to multiple systems and make multiple changes”
“Multiple users login daily to multiple systems to verify multiple changes”
“99% quality requirements, 100% confidentiality and 99.9% accuracy expected”

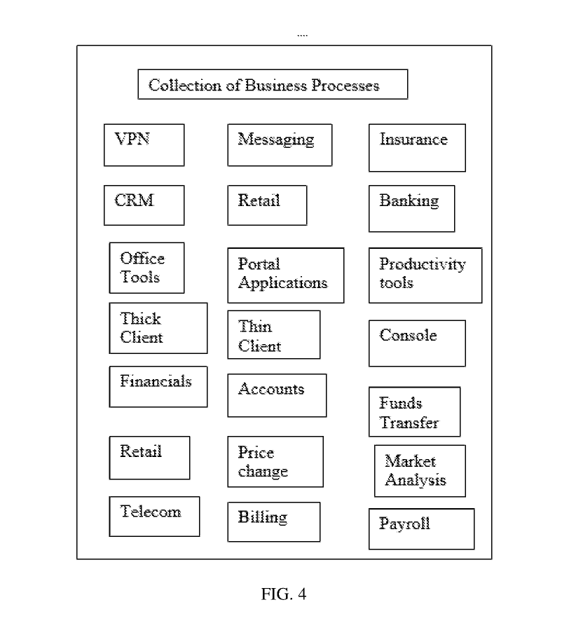

According to an embodiment of the present disclosure, at step 303(b), the one or more hardware processors 104 define a plurality of information entities corresponding to a set of architectural problems and a corresponding problem space. The plurality of information entities comprise, inter-alia, properties, relationships and the operations that can be performed on the first set of information generated corresponding to the set of architectural problems. In an example implementation, referring to FIG. 4, the plurality of information entities defined may be referred, wherein the plurality of information entities comprise multiple entities of a business process facilitating an implementation of robotic process automation deployment.

According to an embodiment of the present disclosure, at step 303(c), the one or more hardware processors 104 synthesize using the plurality of data entities, a second set of information, wherein the second set of information comprises a plurality of data, models, one or more solutions properties and one or more solution snippets corresponding to the set of architectural problems. In an embodiment, the synthesizing comprises creating solutions by amalgamating architectural concepts, architecture principles, solution properties, partial solution snippets and design patterns.

In an example implementation of the step 303(c), suppose for the robotic process automation deployment architectural problem, the identified stakeholders comprise customer, customer's customer, service provider, agent, Government and customer's employees. The values that the stakeholder may seek from the robotic process automation deployment may comprise of pay on time, on demand and high quality work, innovative solutions and processes (customer's values), non-linear growth, brand and market share (customer's customer), and more job opportunities, more tax etc. (Government). Similarly, the values may be identified and defined for all the stakeholders.

The purpose of the robotic process deployment may be defined as “An environment for automating activities using different tools in a coordinated manner (An IT Robot)” to emulate human activity in a computer, run automated computer tasks, perform tasks that are simple and repetitive at a higher rate, perform tasks with high endurance, reliability, precision and speed, organize tasks for integration, repeatability and scalability and manipulate and interact with computer systems to facilitate automation. The quality characteristics may be defined as 24×7 Usage, low footprint, high performance, seamless integration, plug and playable adapters, extensible automation agents, concurrent instances and multiple concurrent automation. The conceptual mapping may comprise replacing human with robot(s). Further, architectural principles or objectives may be defined as:

| Architecture Principles | Remarks |
|---|---|
| Simplicity | Simple agents performing |
| | specific human actions |
| Compatible support elements | Only compatible agents can be |
| | plugged in |
| Grouping and Separation | Related agents are grouped |
| | together |
| Minimal communication | Only relevant information is |
| | manipulated |
| Independent partitioning/low | Works within the boundaries |
| complexity | |
| Least privilege | Does not elevate user privileges |
| Economy | Small in size, Optimized for |
| | speed |

Architectural functionalities may comprise that the robotic process automation deployment must have safety, effectiveness, ease of use, reduction in latency, compliance, fault tolerance, speed of transacting, scalability of transactions and may have simplicity, plan and scheduling etc. Further, a set of architectural functionalities may comprise reusability of defined tasks, reductionism of complicated computer tasks, mass customization and deployment, confidentiality of information and flow control, while a set of architectural non-functionalities may comprise user assistance, maintainability of defined tasks, extensibility and extendibility etc.

Finally, the synthesized third set of information may comprise a plurality of architectural engineering functional qualities, for example, unattended 24×7 hours enactment, unlimited data manipulation, background processing, less storage space, 9×4 levels of data protection and a plurality of architectural engineering non-functional qualities, for example, customizable speed and user defined delays, wherein the plurality of architectural engineering functional qualities and the plurality of architectural engineering non-functional qualities are obtained based upon a series of sub-steps executed under the step 303(c).

According to an embodiment of the present disclosure, at step 303(d), the one or more hardware processors 104 generate based upon the synthesized second set of information, a third set of information comprising of analysis on a set of architectural solutions. In an example implementation, suppose for a problem scenario “Entertainment available on Demand”, the set of architectural problem(s) identified comprises “Ad-hoc entertainment on different occasions”. Based upon the generation of analysis on the set of architectural problems, defining the plurality of data entities and the synthesized second set of information, the analysis on the set of architectural solutions (or the third set of information) may comprise, for example, generating SWOT analysis as identified strengths comprising packaged solutions available host of features and capabilities, bundled with content services, support for many protocols, fixed cost & fixed interfaces, identified weaknesses comprising not all protocols are available, not interoperable with new systems, interfaces are not extensible, storage space limitation, identified opportunities comprising accessories market, plug-ins market and content conversion services and identified threats comprising supplier out-of-business, huge storage costs and huge licensing costs.

According to an embodiment of the present disclosure, at step 303(e), the one or more hardware processors 104 identify based upon the third set of information, a set of potential architectural solutions. In an example implementation, suppose for a problem scenario “Entertainment available on Demand”, the set of architectural problem(s) identified comprises inter-alia, “Ad-hoc entertainment on different occasions”. Based upon the third set of information, a potential architectural solution may be identified as below:

Home Theatre SWOT Analysis
Characteristics
   Best-in-class sound experience
      TV, Audio, Movies, Sports, Drama, Music
   Premium performance at affordable cost
      Many options, packed with features & technologies
   Real cinema experience
      Reproduces theatre experience and feeling
   Home theatre in a box
      Integrated sound-video-content management & rendering solutions
   Media centre
      Computer centric audio-video entertainment system
Strengths
   Packaged solutions available
   Host of features and capabilities
   Bundled with content services
   Support for many protocols
   Fixed cost & fixed interfaces
Weaknesses
   Not all protocols are available
   Not interoperable with new systems
   Interfaces are not extensible
   Storage space limitation
Opportunities
   Accessories market
   Plug-ins market
   Content conversion services
   Content licensing services
   Maintenance contracts
   Rental/Leasing services
   Enhanced products
Threats
   Technology obsolescence
   Huge network costs
   Huge service costs
   Huge spare parts costs

Entertainment Hub SWOT Analysis
Characteristics
   Integration platform for devices of different form factors
      Audio, Video, Still, Mobile devices, Computers, Display panels, . . .
   Control centre for devices of different form factors
      Delivers content in different forms based on desired configuration
   License manager for different types of content
      Access control, Decoding, Decryption, Certificate management, . . .
   Content aggregator for different types of content providers
      Provides access to different content based on end-user needs
   Immersive experience extended to the entire House
      Content access & delivery to any part of the house
      Ubiquitous, convenient, on-demand access to a shared pool of media resources
Strengths
   Interfaces devices of different form factors
   Many devices share same content license
   Life of legacy devices is extended
Weaknesses
   Content licensing may be troublesome
   Variable cost due to many personalized interfaces
   Dedicated hardware
Opportunities
   Conversion services
   Licensing services
   Infrastructure maintenance services
   Content management services
   Upgrading devices
Threats
   Supplier out-of-business
   Huge storage costs
   Huge licensing costs
   Huge infrastructure costs
   Device interfacing

Trade-off Analysis
Home Theatre
   Low cost of ownership
   Off the shelf products
   Dedicated room for theatre experience
   Limited content usability
   Limited interfaces
   Limited extensibility
   Single use licenses
   Dedicated infrastructure
   Huge initial costs
   Entertainment Hub
High cost of ownership
   Off the shelf devices
   Personalized system
   Entire house is the theatre
   Content sharing
   Multiple interfaces
   Plug & Play of devices
   Multiple use of licenses
   Shared infrastructure
   Less initial costs→Choice→Entertainment Hub

According to an embodiment of the present disclosure, at step 303(f), the one or more hardware processors 104 formulate, by implementing one or more architecture techniques amongst the architecture techniques 204 for example, the style analysis 225, a set of potential architectural designs, wherein the set of potential architectural designs correspond to one or more potential architectural solutions amongst the set of potential architectural solutions identified. In an embodiment, the architecture technique 204 is a placeholder for identifying potential architectures for an architecture problem. The architecture technique 204 brings together key decisions necessary for arriving at an architecture including value, quality, function, context, process and structure thereby facilitating the composition of the building blocks of a system (that is, a system under than the system 100). The architecture technique 204 facilitates multiple descriptions of architecture(s) as well as multiple ways of evaluating architectures.

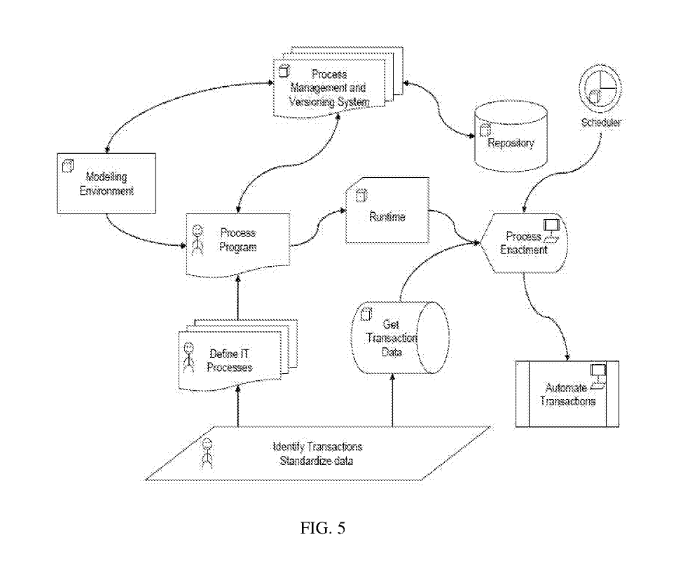

In an example implementation for the step 303(f), referring to FIG. 5, a potential architectural design formulated may be referred, wherein the potential architectural design comprises an operational view of the robotic process automation deployment. Similarly, the set of potential architectural designs comprising of other potential architectural designs, for example, an open source components view may be formulated. In an embodiment, the potential architecture design(s) amongst the set of potential architectural designs is defined by at least one of one or more Architecture Description Languages (ADL) or one or more Architecture Description Models (ADM), for example, Algebras, ACME architecture description language, Wright architecture description language etc.

In an embodiment, the step of formulation of the set of potential architectural designs comprises evaluating, based upon the one or more evaluation techniques, the set of potential architectural designs for generating the multi-functional architectural design. For example, the architecture technique 204 may provide for obtaining a scenario based analysis, cost benefit analysis, risk analysis, quantitative Analysis and Value assessment etc.

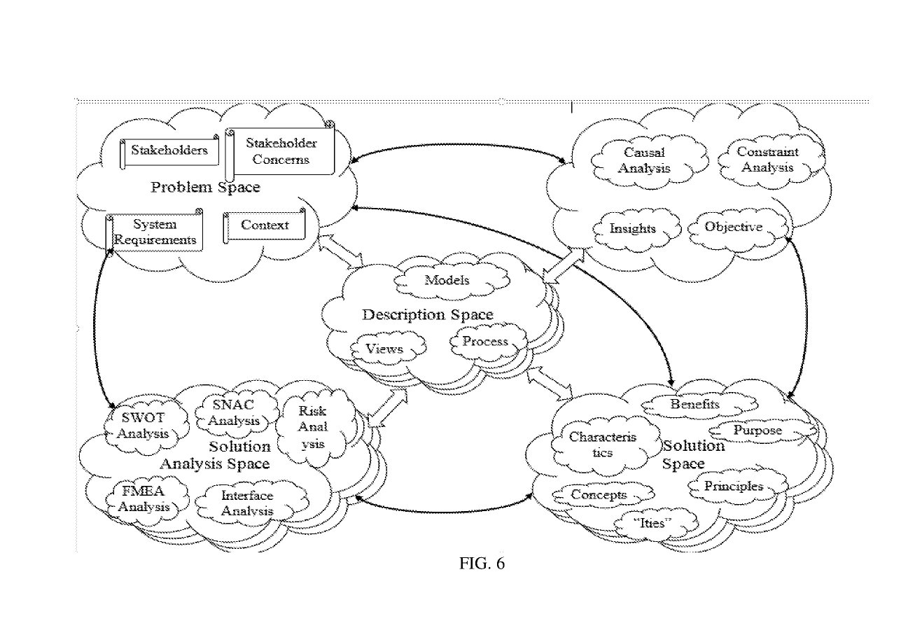

According to an embodiment of the present disclosure, at step 304(a), the one or more hardware processors 104 logically integrate in a hierarchy, a plurality of architecture artefacts and a plurality of architecture work-products based upon the structured set of information, wherein the plurality of architecture artefacts and the plurality of architecture work-products correspond to the ADE 200. The logical integration is performed by implementing by the architecture technique component 204. In an embodiment plurality of architecture artefacts comprise architecture views, architecture models (other than the Architecture Model 209) and architecture views. The plurality of architecture work-products provides a comprehensive architectural overview of computer system(s), using a number of different architectural views to depict different aspects. The integration is logical as it is performed based upon the structured set of information, and the structured set of information is obtained after executing a series of logical steps in a defined order (that is, steps 301 to 303). In an example implementation of the step 304(a), referring to FIG. 6, the plurality of architecture artefacts and the plurality of architecture work-products logically integrated in a hierarchy may be referred, wherein the Risk Analysis, SWOT analysis etc. comprise examples of the plurality of architecture artefacts, while Stakeholders, Stakeholders concerns comprise examples of the plurality of architecture work-products. The technical improvements facilitated by the proposed invention by the logical integration may now be considered in detail.

In the traditional systems and methods, architectures are considered and expressed as a set of architecture views or models (essentially a list of views or models which is a flat structure). As a result, not all relevant information may be captured, for example, subsystem architecture related information. Most of the times, these are embedded as part of the views/models themselves. Any modification, requires dealing with the set of architecture views or models and drilling down the details to effect the change. By creating a hierarchy of such artefacts, accessing and making changes to the individual views/models is straight forward. Additionally, the biggest difficulty with current architecture descriptions are that it is not complete. Architects when presented with an architecture description need to spend sufficient time and effort to identify all the information pertaining to that particular architecture. The proposed disclosure facilitates capturing all information that are necessary for an architect to understand an architecture is packaged together with the architecture description 212 thereby reducing the time and effort involved in modifying the architectures.

According to an embodiment of the present disclosure, at step 304(b), the one or more hardware processors 104 map, by implementing the architecture technique component 204, the first set of information, the second set of information, the third set of information, the set of potential architectural designs and the set of potential architectural solutions. The technical improvements facilitated by the proposed invention by the mapping of the second set of information, the third set of information, the set of potential architectural designs and the set of potential architectural solutions may now be considered in detail.

In the traditional systems and methods, architects manually take a set of requirements and workout a set of architecture views and models that will address these requirements. The way they arrive at the architecture designs and related descriptions is not guided by systematic approach or technique. There are community of practices established in the field which architects who are familiar with these practices utilize. The proposed disclosure by providing for the ADE 200 facilitates a systematic and automated approach towards architecting. It can not only support the community practices but can also enable any new technique that the architect things about. All of it can be plugged into the ADE 200 and then it will enable architecting using that particular technique/approach.

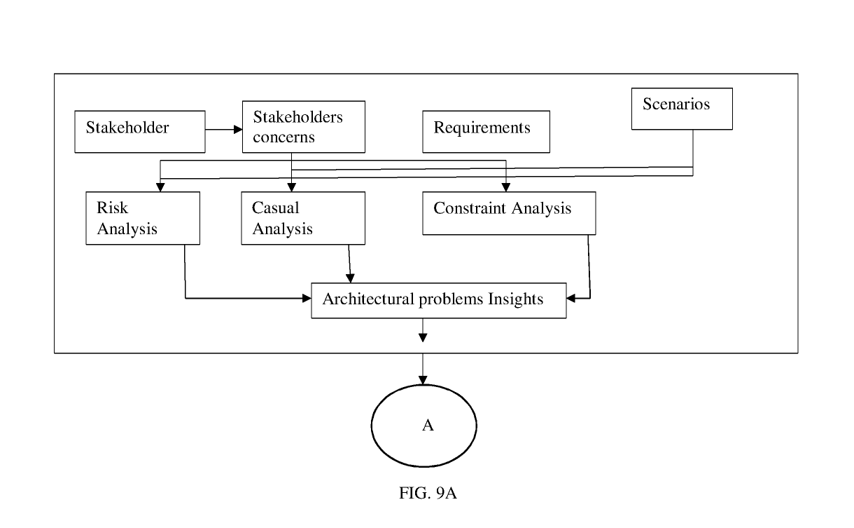

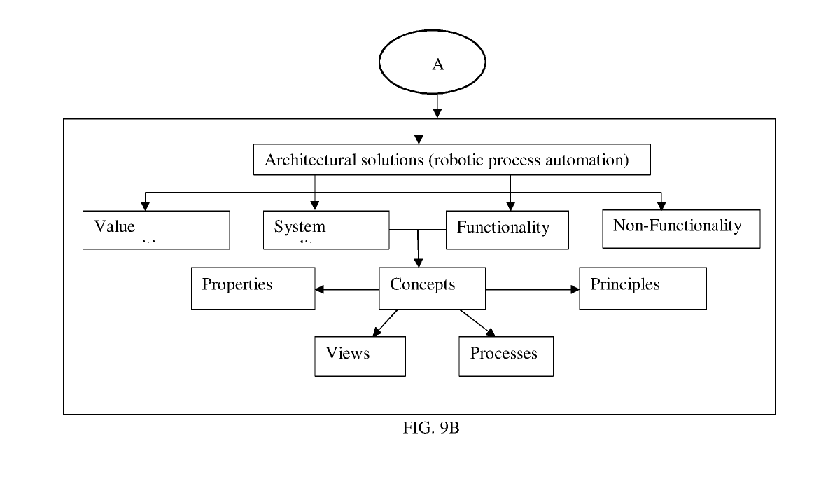

In an example implementation of the step 304(b), referring to FIG. 9A through 9B, the mapping performed by implementing the architecture technique component 204 may be referred, wherein stakeholder(s) (a user of the robotic process deployment) and the stakeholder's concerns are mapped with the set of architectural problems gathered and then transformed into the structured set of information. Further, the mapping of the set of architectural problems with the a set of potential architectural solutions and with functionalities like automating transactions, non-functionalities like speed of use with the robotic process deployment may also be referred.

According to an embodiment of the present disclosure, at step 304(c), the one or more hardware processors 104 generate using one or more architectural description techniques, a fourth set of information comprising one or more architectural descriptions, views and models corresponding to each potential architecture solution amongst the set of potential architectural solutions. In an embodiment, the fourth set of information comprise multiple views like component view, composition view, sub-system view, interface extensions view etc. Further, the one or more architectural description techniques via which the fourth set of information may be generated comprises the Process Description 227, the Behavior Description 228, and the Constraints Description 230 etc. The technical improvements facilitated by the proposed invention by the generation of the fourth set of information, may now be considered in detail.

In the traditional systems and methods, architecture descriptions are traditionally comprise a set of views collated together. The architecture descriptions in the traditional systems and methods do not contain information about the architecture problems, architecture solutions, alternative architectures, alternative solutions, decisions, rationale for these decisions, various analysis performed and so on. The proposed disclosure facilitates integrating and collating (packaging) all the information pertaining to an architecture into the architecture description 212 by means of generation techniques thereby enriching the architecture related information and enabling ease of modification and understanding of the architectures.

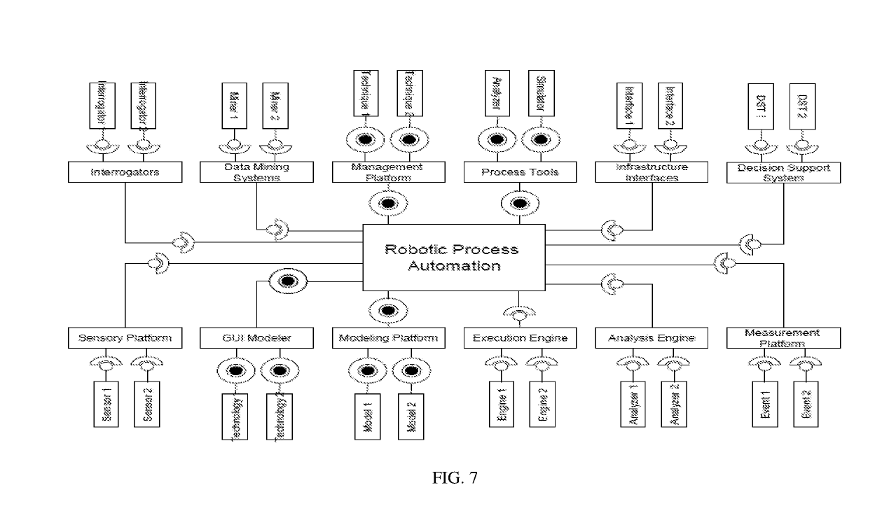

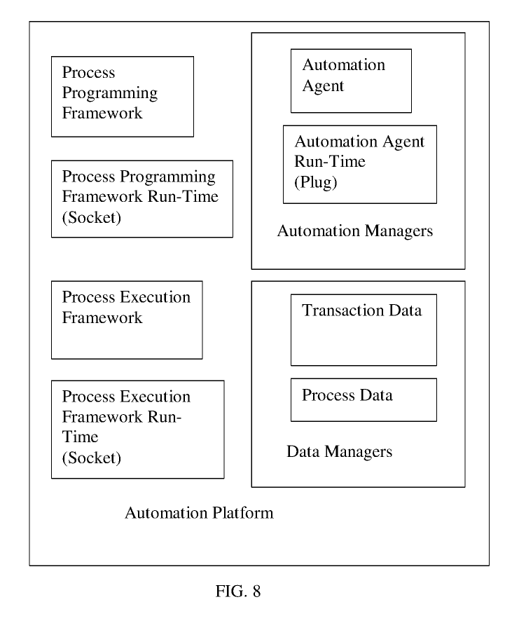

In an example implementation of the step 304(c), referring to FIGS. 7 and 8, the fourth set of information comprising of the one or more architectural descriptions, views and models corresponding to each of the potential architecture solution amongst the set of potential architectural solutions may be referred.

According to an embodiment of the present disclosure, at step 305, the one or more hardware processors 104 facilitate the inter-environmental architecture implementation by initially identifying, at step 305(a), a final architectural design amongst the set of potential architectural designs, wherein the final architectural design corresponds to the one or more potential architectural solutions amongst the set of architectural solutions. The final architectural design provides for one or more complete architectural solutions by implementing the proposed methodology by executing the steps 301 to 304. In an example implementation of the step 305(a), referring to FIG. 9A through 9B, the final architectural design identified may be referred, wherein the final architectural design corresponds to the robotic process deployment. Further, referring to below Tables 1 and 2 below, description of the final architectural designs in the tabular form may be referred, wherein both the final architectural designs correspond to the one or more potential architectural solutions.

In an embodiment, the final architectural design identification comprises defining a unified standard of interaction corresponding to the defined plurality of architectural components based upon the component model 216, for example, plug or sockets interaction standard, data source and data sink interaction standard.

TABLE 1

| | | | | |
|---|---|---|---|---|
| Key Partners | Key | Value | Customer | Customer |
| Service | Activities | Proposition | Relationship | Segments |
| Providers | Coordinate | Participants: | Recognition | Businesses |
| Communities | Acquire | Pioneer | Experiential | Service |
| Suppliers | Aggregate | Experiences | Learning | Providers |
| Participants | Organize | Service | Co-create | Participants |
| Sponsors | Manage | Providers: | Channels | Sponsors |
| Host | Key | Recognition | Social Media | Facilitators |
| | Resources | and | Communication | |
| | Venue | Expansion | Channels | |
| | Speakers | Customers: | Participants | |
| | Sponsors | Thought | Live Streaming | |
| | Facilitators | Leadership | | |
| | Technology | Offerings | | |
| | | Capabilities, | | |
| | | Services and | | |
| | | Resources | | |

| | |
|---|---|
| Cost Structure | Revenue Streams |
| Service Costs | Investments |
| Infrastructure Costs | Sponsorship |
| Hiring Costs | Advertisements |
| Equipment Costs | Business Deals |
| Transport, logistics, Catering costs | |

TABLE 2

| | | | | |
|---|---|---|---|---|
| Key Partners | Key | Value | Customer | Customer |
| Service | Activities | Proposition | Relationship | Segments |
| Providers | Marketing | Participants: | Collaborators | Businesses: |
| Other Event | Brand | Great | Co-Producers | Event Design, |
| Hosts | Management | Experiences | Co-Innovators | Management |
| Acquired | Event design | Service | Channels | and Hosting |
| Companies | Event | Providers: | Digital Forces | Service |
| Advertisers | orchestration | Repeatability | Word of Mouth | Providers: |
| Sponsors | Entertainment | and Diversity | Media and | Service |
| Suppliers | Key | Customers: | Communication | Aggregator |
| Infrastructure | Resources | One shop for | Channels | Participants: |
| providers | Technologies | everything on | | Event Hosting |
| | Capabilities | Events | | |
| | Services | Offerings | | |
| | Teams | Capabilities | | |
| | Knowledge | Services and | | |
| | | Resources | | |

| | |
|---|---|
| Cost Structure | Revenue Streams |
| Event Design, Development & Maintenance | Technology licenses |
| Expenses | IPR licenses & royalties |
| Infrastructure Development & Maintenance | Event design and hosting revenues |
| expenses | Event management revenues |
| Standardization, Deployment & Scaling | Advertising revenues |
| expenses | Service related revenues |
| Sourcing, Supply chain & Aggregating Expenses | |
| Alliances and Networking expenses | |

According to an embodiment of the present disclosure, at step 305(b), the one or more hardware processors 104 generate a final set of integrated architectural descriptions, wherein the final set of integrated architectural descriptions correspond to the one or more potential architectural solutions amongst the set of architectural solutions. The final set of integrated architectural descriptions provides for a brief summary of the final architectural design generated corresponding to the set of architectural problems identified. In an example implementation of the step 305(b), referring to Table 3, the final set of integrated architectural descriptions for an event company looking to adopt digital technologies may be referred.

TABLE 3

| Dimension | Intervention | Core idea | Value Proposition |
|---|---|---|---|
| Event | Event Life-Cycle | Enabling the process | Smartest way to |
| Dimension | Management | descriptions of the life-cycle of | conduct events |
| | | events | Inspiring |
| | | | opportunities to |
| | | | make a difference |
| | Event Modelling | Environment to support | Smartest way to |
| | and | different kinds of events | design & host |
| | Orchestration | | events |
| | | | Co-Create |
| | | | moments of magic |
| | | | Be the difference |
| | Event | Generic conceptual framework | Leveraging |
| | Framework | to support planning, execution, | technologies, |
| | | management & documentation | capabilities, |
| | | of events | innovations |
| | | | Increased flexibility |
| | | | in Event operations |
| | | | Reduced cost and |
| | | | complexity |
| Experience | Experience | Enabling the process | Experience as a |
| Dimension | Producer | descriptions of the life-cycle | Theatre |
| | | of experiences | Immersive |
| | | | Experiences |
| | Experience | Evaluation framework to | Smart Technology |
| | Evaluation | support assessment of | Assured |
| | Framework | experiences | Experiences |
| | Experience | Aggregation of Experiences | Normalized Market |
| | Aggregator | provided by different | Perpetual Evolution |
| | | Experience providers | On demand |
| | | | experiences |
| Business | Convention | Single shop for all Event | End-to-end |
| Dimension | Centre | needs | Systems, Solutions, |
| | | | Services |
| | | | Professional |
| | | | hosting |
| | Disney World | ingle shop for all Experience | Great, immersive, |
| | | needs | memorable |
| | | | experiences |
| | | | Impacting people in |
| | | | a positive way |

In an embodiment, the memory 102 can be configured to store any data that is associated with generating the multi-functional architectural design to facilitate the inter-environmental architecture implementation. In an embodiment, information or data pertaining to the first set of information, the second set of information, the third set of information, the fourth set of information, the final architectural design, the mapping and the final set of integrated architectural descriptions etc. gets stored in the memory 102. Further, all information (inputs, outputs and so on) pertaining to generating the multi-functional architectural design to facilitate the inter-environmental architecture implementation may also be stored in the database, as history data, for reference purpose.

The present invention possesses following capabilities (that is, the capabilities of the ADE 200): Ability to Create and Manipulate any Architecture Models (other than the Architecture Model 209), create and Manipulate Architecture Views, create and Manipulate the Usage Processes, enact chosen Architecture process and support its execution in terms of providing sufficient resources, supporting roles and creating appropriate artefacts, define resources necessary for the Architecture, define different viewpoints and enable creation of appropriate Architecture Views, express architectures in different Architecture Description Languages, manipulate architectures and provide multiple visualizations, assess the correctness and consistency of an Architecture (Description, Model, View), provide the plurality of architecting workspaces 203 for creating and manipulating architectures, provide repository for storing and manipulating architecture related information, model stakeholders, their concerns, drivers for change, goals, objectives and requirements, express architectural rules, principles, constraints and guidelines, create and manipulate Architecture design patterns, enable visual manipulation of architecture artefacts, define functional and non-functional characteristics of the resultant architecture, aid in the definition of quality breakdown structure, process breakdown structure, aid in the specification of components and their composition, establish traceability between components, qualities and processes, extract views for various Viewpoints from Unified model of the Architecture, support working on multiple architectures Support versioning and Base-lining of Architectures, architects should be able to seamlessly move information between multiple workspaces, incompatibilities in View creation/manipulation should be handled gracefully, ability to handle different types of architecture models (other than the Architecture Model 209), processes and techniques, ability to tailor different architecture models (other than the Architecture Model 209), processes and techniques, drag and drop, point and click capabilities to support architecting.

The present disclosure possesses following additional technical improvements pertaining to an underlying Architecture Component Framework (not shown in the figure) and thus, by implementing the steps 301 through 305 (discussed via use of examples in the preceding paragraphs), it facilitates the inter-environmental architectural implementation. The technical improvements comprise, there is a common elemental data structure/schema for the data so that interoperability can be supported, the schema is extensible, there is a common collection of primitive Graphical User Interface (GUI) elements using which all the user interactions are expressed, the collection is extensible. Architecting functionalities are encoded as part of run-time environment or as a reusable Component. Further, there are mechanisms to specify functionality that is desired by a tool as part of its process and this functionality is extensible. Also, there is the process model 213 and an underlying notation to express all processes. Still further, there are mechanisms to support definition, analysis, manipulation and execution of processes and information from stakeholders can be collected in any format, and finally, it is possible to store the progress of a process and the corresponding data during its execution.

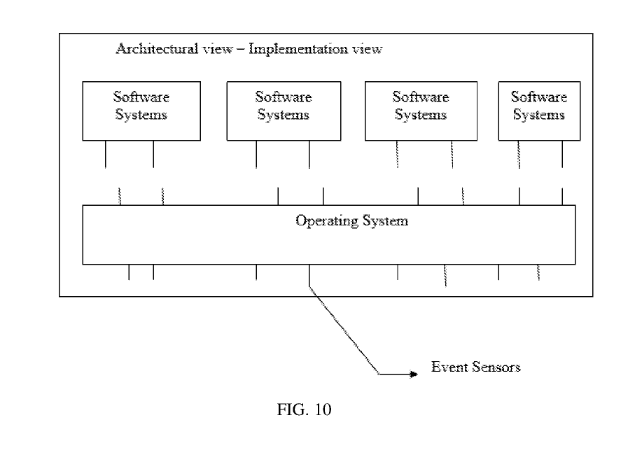

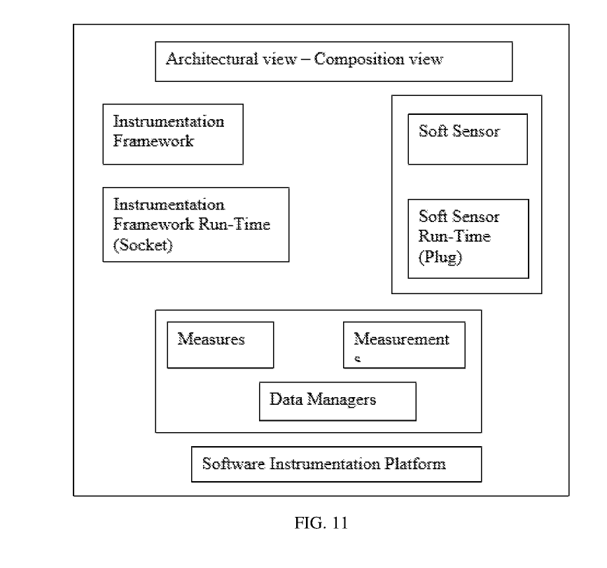

In an example implementation of the facilitation of the inter-environmental architectural implementation, the proposed disclosure may be implemented for a software instrumentation, comprising of the set of architectural problems like asserting overall software quality, large, complex and sophisticated software system, rich user experience, device independence and Mobility, social networking, unstructured big data, real time response and intelligence, end-user computing devices and information from them is the bottle-neck, and End-users use information technology accessible thru desktops to support business processes. By implementing the proposed methodology, referring to FIGS. 10 and 11, the architectural descriptions, views and models generated corresponding to each potential architecture solution amongst the set of potential architectural solutions (for example, soft sensors listening for events, only compatible sensors can be plugged in, listen, capture and dispatch event data, event specific soft sensors) may be referred. Further, the final set of integrated architectural descriptions (not shown or described) may be generated. Similarly, the proposed disclosure may applied to other sets of architectural problems to facilitate the inter-environmental architecture implementation.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of generating multi-functional architectural design to facilitate an inter-environmental architecture implementation in a computing device, the method comprising a processor implemented steps of:
defining, by one or more hardware processors, a plurality of architectural components, wherein the plurality of architectural components comprise a plurality of architecting workspaces, an architecture technique, a run-time and an architecture repository, and wherein the plurality of architecting workspaces comprise inter-alia of a process model and a component model (301);
obtaining, from the architecture repository, an unstructured set of information comprising of an analytical data and a non-analytical data relevant to a set of architectural problems, wherein the unstructured set of information is gathered from a plurality of sources (302);
transforming, by performing a plurality of steps, the unstructured set of information into a structured set of information by the plurality of architecting workspaces, wherein the plurality of steps comprise:
(a) generating, by implementing one or more analysis techniques, a first set of information comprising of analysis on the set of architectural problems (303(a));
(b) defining a plurality of information entities corresponding to the set of architectural problems (303(b));
(c) synthesizing, using the plurality of information entities, a second set of information, wherein the second set of information comprises a plurality of data, models and solutions corresponding to the set of architectural problems (303(c));
(d) generating, by implementing the one or more analysis techniques, a third set of information comprising of analysis on a set of architectural solutions (303(d));
(e) identifying, based upon the third set of information, a set of potential architectural solutions (303(e)); and
(f) formulating, by the architecture technique, a set of potential architectural designs, wherein the set of potential architectural designs correspond to one or more architectural solutions amongst the set of potential architectural solutions identified (303(f));
performing, based upon the structured set of information, at least one of one of below by implementing the architecture technique:
(a) logically integrating in a hierarchy a plurality of architecture artefacts and a plurality of architecture work-products (304(a));
(b) mapping the first set of information, the second set of information, the third set of information, the set of potential architectural designs and the set of potential architectural solutions (304(b)); and
(c) generating, using one or more architectural description techniques, a fourth set of information comprising one or more architectural descriptions, views and models corresponding to each potential architecture solution amongst the set of potential architectural solutions (304(c)); and
facilitating, based upon the one or more architectural description techniques and the mapping, the inter-environmental architecture implementation by:
(a) identifying a final architectural design amongst the set of potential architectural designs, wherein the final architectural design corresponds to one or more potential architectural solutions amongst the set of potential architectural solutions (305(a)); and
(b) generating a final set of integrated architectural descriptions, wherein the final set of integrated architectural descriptions correspond to the one or more potential architectural solutions amongst the set of potential architectural solutions (305(b)).

2. The method of claim 1, wherein the step of formulating the set of potential architectural designs comprises evaluating, based upon one or more evaluation techniques, the set of potential architectural designs for generating the multi-functional architectural design, and wherein the evaluation comprises analyzing the set of potential architectural designs using the one or more analysis techniques.

3. The method of claim 1, wherein the step of formulating the set of potential architectural designs is preceded by identifying, based upon at least one of a built-in function or a plug-in function, a set of functionalities and a set of architectural resources to execute the plurality of architectural components.

4. The method of claim 1, wherein a potential architecture design amongst the set of potential architectural designs is defined by at least one of one or more Architecture Description Languages (ADL) or one or more Architecture Description Models (ADM).

5. The method of claim 1, wherein the step of defining the plurality of architectural components comprises defining a plurality of tasks for executing the architecture technique based upon the process model.

6. The method of claim 5, wherein the step of defining the plurality of tasks comprises defining one or more sequences corresponding to the plurality of tasks based upon the process model, and wherein the one or more sequences determine the order in which the plurality of tasks are to be executed.

7. The method of claim 1, wherein the step of identifying the final architectural design comprises defining a unified standard of interaction corresponding to the defined plurality of architectural components based upon the component model.

8. A system (100) for generating multi-functional architectural design to facilitate an inter-environmental architecture implementation in a computing device, the system (100) comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
define, by the one or more hardware processors (104), a plurality of architectural components, wherein the plurality of architectural components comprise a plurality of architecting workspaces (203), an architecture technique (204), a run-time (202) and an architecture repository (201), and wherein the plurality of architecting workspaces (203) comprise inter-alia of a process model (213) and a component model (216);
obtain, from the architecture repository (201), an unstructured set of information comprising of an analytical data and a non-analytical data relevant to a set of architectural problems, wherein the unstructured set of information gathered from a plurality of sources;
transform, by performing a plurality of steps, the unstructured set of information into a structured set of information by the plurality of architecting workspaces (203), wherein the plurality of steps comprise:
(a) generate, by implementing one or more analysis techniques, a first set of information comprising of analysis on the set of architectural problems;
(b) define a plurality of information entities corresponding to the set of architectural problems;
(c) synthesize, using the plurality of information entities, a second set of information, wherein the second set of information comprises a plurality of data, models and solutions corresponding to the set of architectural problems;
(d) generate, by implementing the one or more analysis techniques, a third set of information comprising of analysis on a set of architectural solutions;
(e) identify, based upon the third set of information, a set of potential architectural solutions; and
(f) formulate, by the architecture technique (204), a set of potential architectural designs, wherein the set of potential architectural designs correspond to one or more architectural solutions amongst the set of potential architectural solutions identified;
perform, based upon the structured set of information, at least one of one of below by implementing the architecture technique (204):
(a) logically integrate in a hierarchy a plurality of architecture artefacts and a plurality of architecture work-products;
(b) map the first set of information, the second set of information, the third set of information, the set of potential architectural designs and the set of potential architectural solutions; and
(c) generate, using one or more architectural description techniques, a fourth set of information comprising one or more architectural descriptions, views and models corresponding to each potential architecture solution amongst the set of potential architectural solutions; and
facilitate, based upon the one or more architectural description techniques and the mapping, the inter-environmental architecture implementation by:
(a) identify a final architectural design amongst the set of potential architectural designs, wherein the final architectural design corresponds to one or more potential architectural solutions amongst the set of potential architectural solutions; and
(b) generate a final set of integrated architectural descriptions, wherein the final set of integrated architectural descriptions correspond to the one or more potential architectural solutions amongst the set of potential architectural solutions.

9. The system (100) of claim 8, wherein the step of formulating the set of potential architectural designs comprises evaluating, based upon one or more evaluation techniques, the set of potential architectural designs for generating the multi-functional architectural design, and wherein the evaluation comprises analyzing the set of potential architectural designs using the one or more analysis techniques.

10. The system (100) of claim 8, wherein the one or more hardware processors (104) are configured to formulate the set of potential architectural designs by identifying, based upon at least one of a built-in function (207) or a plug-in function (208), a set of functionalities and a set of architectural resources to execute the plurality of architectural components.

11. The system (100) of claim 8, wherein a potential architecture design amongst the set of potential architectural designs is defined by at least one of one or more Architecture Description Languages (ADL) or one or more Architecture Description Models (ADM).

12. The system (100) of claim 8, wherein the one or more hardware processors (104) are configured to define a plurality of tasks for executing the architecture technique (204) based upon the process model (213).

13. The system (100) of claim 12, wherein the one or more hardware processors (104) are configured to define one or more sequences corresponding to the plurality of tasks based upon the process model (213), and wherein the one or more sequences determine the order in which the plurality of tasks are to be executed.

14. The system (100) of claim 8, wherein the one or more hardware processors (104) are configured to step of identify the final architectural design by defining a unified standard of interaction corresponding to the defined plurality of architectural components based upon the component model (216).

15. One or more non-transitory machine readable information storage mediums comprising one or more instructions which when executed by one or more hardware processors causes the one or more hardware processor to perform a method for generating multi-functional architectural design to facilitate an inter-environmental architecture implementation in a computing device, said method comprising:
defining, by one or more hardware processors, a plurality of architectural components, wherein the plurality of architectural components comprise a plurality of architecting workspaces, an architecture technique, a run-time and an architecture repository, and wherein the plurality of architecting workspaces comprise inter-alia of a process model and a component model;
obtaining, from the architecture repository, an unstructured set of information comprising of an analytical data and a non-analytical data relevant to a set of architectural problems, wherein the unstructured set of information is gathered from a plurality of sources;
transforming, by performing a plurality of steps, the unstructured set of information into a structured set of information by the plurality of architecting workspaces, wherein the plurality of steps comprise:
(a) generating, by implementing one or more analysis techniques, a first set of information comprising of analysis on the set of architectural problems;
(b) defining a plurality of information entities corresponding to the set of architectural problems;
(c) synthesizing, using the plurality of information entities, a second set of information, wherein the second set of information comprises a plurality of data, models and solutions corresponding to the set of architectural problems;
(d) generating, by implementing the one or more analysis techniques, a third set of information comprising of analysis on a set of architectural solutions;
(e) identifying, based upon the third set of information, a set of potential architectural solutions; and
(f) formulating, by the architecture technique, a set of potential architectural designs, wherein the set of potential architectural designs correspond to one or more architectural solutions amongst the set of potential architectural solutions identified;
performing, based upon the structured set of information, at least one of one of below by implementing the architecture technique:
(a) logically integrating in a hierarchy a plurality of architecture artefacts and a plurality of architecture work-products;
(b) mapping the first set of information, the second set of information, the third set of information, the set of potential architectural designs and the set of potential architectural solutions; and
(c) generating, using one or more architectural description techniques, a fourth set of information comprising one or more architectural descriptions, views and models corresponding to each potential architecture solution amongst the set of potential architectural solutions; and
facilitating, based upon the one or more architectural description techniques and the mapping, the inter-environmental architecture implementation by:
(a) identifying a final architectural design amongst the set of potential architectural designs, wherein the final architectural design corresponds to one or more potential architectural solutions amongst the set of potential architectural solutions; and
(b) generating a final set of integrated architectural descriptions, wherein the final set of integrated architectural descriptions correspond to the one or more potential architectural solutions amongst the set of potential architectural solutions.

16. The one or more non-transitory machine readable information storage mediums of claim 15, wherein the step of formulating the set of potential architectural designs comprises evaluating, based upon one or more evaluation techniques, the set of potential architectural designs for generating the multi-functional architectural design, and wherein the evaluation comprises analyzing the set of potential architectural designs using the one or more analysis techniques.

17. The one or more non-transitory machine readable information storage mediums of claim 15, wherein the step of formulating the set of potential architectural designs is preceded by identifying, based upon at least one of a built-in function or a plug-in function, a set of functionalities and a set of architectural resources to execute the plurality of architectural components.

18. The one or more non-transitory machine readable information storage mediums of claim 15, wherein a potential architecture design amongst the set of potential architectural designs is defined by at least one of one or more Architecture Description Languages (ADL) or one or more Architecture Description Models (ADM).

19. The one or more non-transitory machine readable information storage mediums of claim 15, wherein the step of defining the plurality of architectural components comprises defining a plurality of tasks for executing the architecture technique based upon the process model, wherein defining the plurality of tasks comprises defining one or more sequences corresponding to the plurality of tasks based upon the process model, and wherein the one or more sequences determine the order in which the plurality of tasks are to be executed.

20. The one or more non-transitory machine readable information storage mediums of claim 15, wherein the step of identifying the final architectural design comprises defining a unified standard of interaction corresponding to the defined plurality of architectural components based upon the component model.
